(19) United States
(12) Patent Application Publication
(10) Pub. No.: US 2024/0385023 A1
(43) Pub. Date: Nov. 21, 2024

(54) Graduated Cylinder

(71) Applicant: Alexander Tae Young LEE, Fairfax, VA (US)

(72) Inventor: Alexander Tae Young LEE, Fairfax, VA (US)

(21) Appl. No.: 18/779,009

(22) Filed: Jul. 21, 2024

(51) Int. Cl. G01F 23/02; G01N 21/25

(52) U.S. Cl. CPC G01F 23/02; G01N 21/251

(57) ABSTRACT

Present invention provides graduated cylinder comprising a main body having a constant inner diameter and outer diameter, a measuring part attached to one side of the main body and having indicia, a color sensor for detecting color information of a liquid to be measured, a controller that determines the complementary color information about the color information of the liquid to be measured from the color sensor, a PWM signal unit that generated PWM signal for driving LEDs based on the complementary color information from the controller, and LEDs that emits complementary color light according to the PWM signal from the PWM signal unit to the measurement part.

### TECHNICAL FIELD

This disclosure is directed in general to a graduated cylinder. More specifically, this disclosure relates to a graduated cylinder of which measurement indicia can be easily read even in the dark environment.

### BACKGROUND

A graduated cylinder, also known as a measuring cylinder or mixing cylinder, is a common piece of laboratory equipment used to measure the volume of a liquid. It has a narrow cylindrical shape. Each marked line on the graduated cylinder is called as “indicia” and represents the amount of liquid that has been measured.

Graduated cylinders are generally more accurate and precise than laboratory flasks and beakers, but they should not be used to perform volumetric analysis; volumetric glassware, such as a volumetric flask or volumetric pipette, should be used, as it is even more accurate and precise. Graduated cylinders are sometimes used to measure the volume of a solid indirectly by measuring the displacement of a liquid.

A traditional graduated cylinder is usually narrow and tall so as to increase the accuracy and precision of volume measurement. It has a plastic or glass base (stand, foot, support) and a spout for easy pouring of the measured liquid.

To read the volume accurately, the observation must be at eye level and read at the bottom of an indicia of the liquid level. The main reason as to why the reading of the volume is done via indicia is due to the nature of the liquid in a closed surrounded space.

By nature, liquid in the cylinder is attracted to the wall around it through molecular forces. This forces the liquid surface to develop either a convex or concave shape, depending on the type of the liquid in the cylinder. Reading the liquid at the bottom part of a concave or the top part of the convex, liquid is equivalent to reading the liquid at its indicia.

Another problem related to reading the indicia is that, when the color of the liquid to be measured is dark or the surrounding light not sufficiently bright, it is difficult to read the fine indicia.

### SUMMARY

The purpose of the present invention is to solve the problems described above, and the graduated cylinder according to the present invention comprises a main body having a constant inner diameter and outer diameter, a measuring part attached to one side of the main body and having indicia, a color sensor for detecting color information of a liquid to be measured, a controller that determines the complementary color information about the color information of the liquid to be measured from the color sensor, a PWM signal unit that generated PWM signal for driving LEDs based on the complementary color information from the controller, and LEDs that emits complementary color light according to the PWM signal from the PWM signal unit to the measurement part.

According to the embodiment, the controller comprises a memory storing color codes and complementary color information about RGB colors.

There are additional features of the graduated cylinder that will be described hereinafter and that will form the subject matter of the claims appended hereto. In this respect, before explaining at least one embodiment of the graduated cylinder in detail, it is to be understood that the graduated cylinder is not limited in its application to the details of construction or to the arrangements of the components set forth in the following description or illustrated in the drawings. The graduated cylinder is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

The patent or application file contains a least one drawing executed in color. Copies of this patent or patent application publication with color drawing(s) will be provided by the Office upon request and payment of the necessary fee.

Example embodiment will become more fully understood from the detailed description given herein below and the accompanying drawings, wherein like elements are represented by like reference characters, which are given by way of illustration only and thus are not limitative of the example embodiments herein, in which:

FIG. 1A shows the diagram demonstrating additive color with RGB Complementary colors in the RGB color model;

FIG. 1B shows RGB Color space coordinate and complementary color examples.

FIG. 2A is an upper perspective view of a graduated cylinder in accordance with an example embodiment;

FIG. 2B is an upper perspective view of a graduated cylinder in accordance with an example embodiment of the prior art; and

FIG. 3 is a block diagram showing the main parts of the graduated cylinder according to the example embodiment.

### DETAILED DESCRIPTION

In the graduated cyclin of the present invention, in order to solve the above-mentioned problems in the prior art, as a main part, a measurement part that is formed on one side of the main body into which light of a color having a complementary color relationship with the color of the liquid to be measured is introduced.

First, the complementary color relationship will be explained as a key concept in the method of solving the problems of the prior art of the present invention.

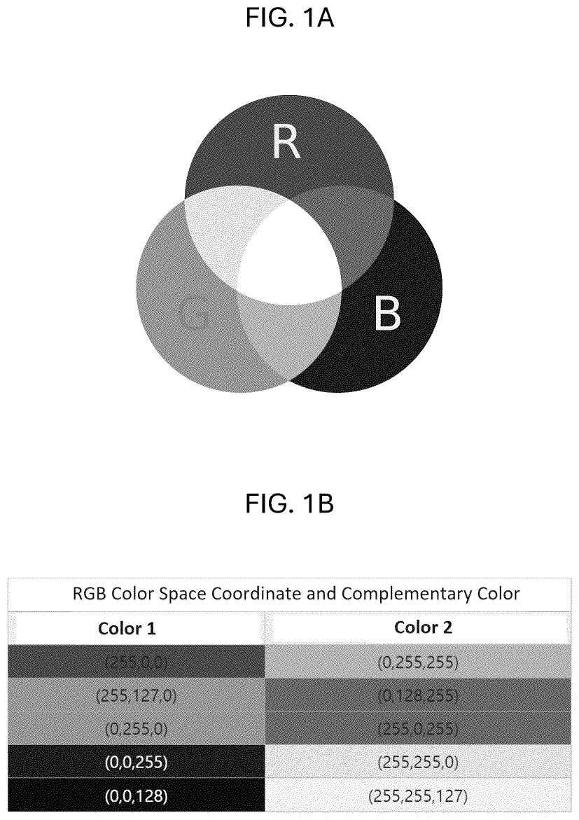

FIG. 1A shows the diagram demonstrating additive color with RGB Complementary colors in the RGB color model. The RGB color model is a kind of additive color model in which the red, green and blue primary colors of light are added together in various ways to reproduce a broad array of colors.

A color in the RGB color model is described by indicating how much of each of the red, green, and blue is included. The color is expressed as an RGB triplet (r,g,b), each component of which can vary from zero to a defined maximum value. If all the components are at zero the result is black; if all are at maximum, the result is the brightest representable white. The component values are often stored as unsigned integer numbers in the range 0 to 255, the range that a single 8-bit byte can offer. These are often represented as either decimal or hexadecimal numbers.

FIG. 1B shows RGB Color space coordinate and complementary color examples. In the respective colors, the numbers inside the parenthesis are the component values of RGB.

Complementary colors are pairs of colors which, when combined or mixed, cancel each other out (lose hue) by producing a grayscale color like white or black. When placed next to each other, they create the strongest contrast for those two colors. Complementary colors may also be called “opposite colors.”

Which pairs of colors are considered complementary depends on the color theory one uses:
Modern color theory uses either the RGB additive color model or the CMY subtractive color model, and in these, the complementary pairs are red-cyan, green-magenta, and blue-yellow.
In the traditional RYB color model, the complementary color pairs are red-green, yellow-purple, and blue-orange.
Opponent process theory suggests that the most contrasting color pairs are red-green and blue-yellow.
The black-white color pair is common to all the above theories.

By using the complementary color relationship, the measurement of volume of the liquid to be measured is much easier than in the prior art. In other words, by introducing light of a color complementary to the color of the liquid to be measured into the measuring part of the graduated cylinder of the present invention, the level of the liquid to be measured can be clearly read on the measuring part.

### Embodiment

Hereinafter, an embodiment of the present disclosure will be described in detail concerning the accompanying drawings so that a person who has ordinary skill in the art can easily implement the present disclosure.

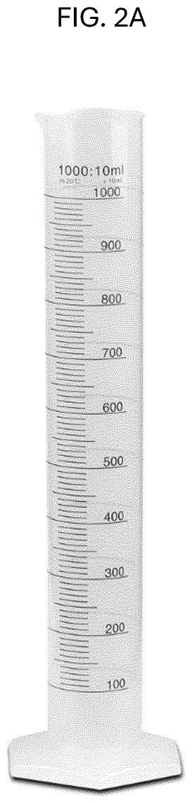

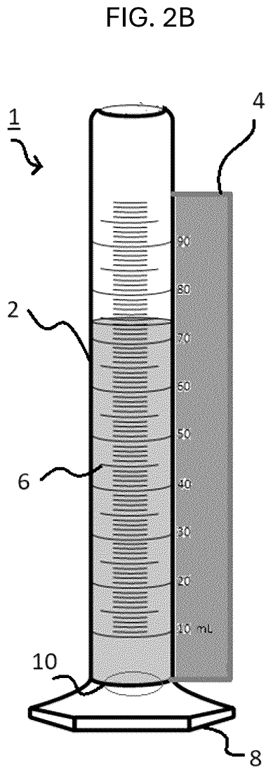

FIG. 2A is an upper perspective view of a graduated cylinder in accordance with an example embodiment of the prior art and FIG. 2B represents an upper perspective view of a graduated cylinder in accordance with an example embodiment of the present invention.

As can be seen by comparing both drawings, if the colored liquid contained in the cylinder of FIG. 2B is placed in the cylinder of FIG. 2A, since the color of the liquid and the color of the cylinder scale are similar, making it very difficult to read the indicia.

However, according to the graduated cylinder of the present invention, since the measurement part of the cylinder introduces the light of color that is complementary to the color of the liquid to be measured, and it will be very comfortable when the circumstance is not so bright or dark.

According to FIG. 2B, the graduated cylinder 1 of the present invention comprises a main body 2, measurement part 4, and base 6.

The main body 2 is made of polypropylene for its chemical resistance or polymethyl pentene for its transparency, making them lighter and less fragile than glass. As a matter of fact, glass can be used too. Each marked line (indicia) 6 on the main body 1 represents the amount of liquid that has been measured.

The graduated cylinder 1 is usually narrow and tall so as to increase the accuracy and precision of volume measurement. The graduated cylinder 1 has a plastic or glass base 8 and a spout (not in the drawing) for easy pouring of the measured liquid.

At the top surface of the base 8, a color sensor 10 is embedded. The color sensor 10 is a type of photoelectric sensor which emits light from a transmitter, and them detects the light reflected back from the detection object, in this case the color of the liquid of which volume to be measured, with a receiver.

The color sensor 10 can detect the received light intensity for red, green and blue respectively, and making it possible to determine the color of the liquid. By calculating the ratio of the intensity of the red, green, and blue light received, it is possible to distinguish differences in the color or appearance of the object.

In the base 8, not only the color sensor 10, but there are also more parts such as controller 14, a PWM signal generator 16 and LEDs 18.

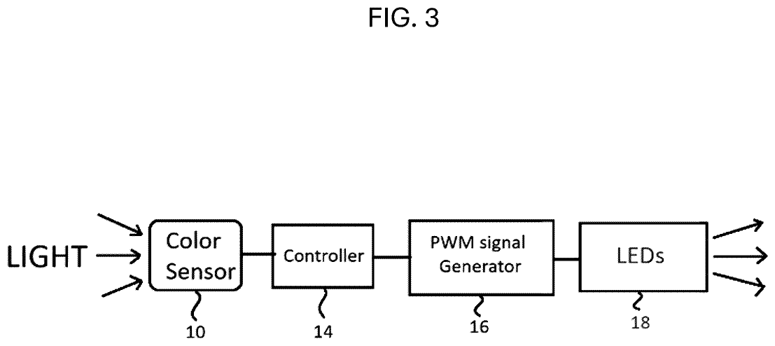

FIG. 3 is a block diagram showing the main parts of the graduated cylinder according to the example embodiment.

When the color sensor 10 emits light to the liquid in the graduated cylinder 1, the liquid reflects the light to the color sensor 10 back, the detect the color information of the reflected light, and send the information to controller 14.

The controller 14 calculates the RGB coordinates from the color sensor 10 and finds the complementary color information saved in a memory. The memory can be incorporated in the controller or separately.

Then, controller 14 sends the color information of the complementary color information to a PWM signal generator 18. The PWM signal generator 18 generates PWM signal based upon the data from the controller 14 to drive the LESs 18.

The LESs 18 makes the complementary color light according to the PWM signal from the PWM signal generator 18 and sends the light to the measurement part 4.

The above description of the present invention is for illustrative purposes only, and a person having ordinary skill in the art to which the present invention pertains will be able to understand that other specific forms can be easily modified without changing the technical spirit or essential features of the present invention. Therefore, the embodiments described above are illustrative and non-limiting in all respects. The scope of the present invention is outlined in the claims rather than in the detailed description, and all changes or modified forms derived from the meaning and scope of the claims and their equivalent concepts should be interpreted as being included in the scope of the present invention.

What is claimed:

1. A graduated cylinder comprising:
a main body having a constant inner diameter and outer diameter,
a measuring part attached to one side of the main body and having indicia;
a color sensor for detecting color information of a liquid to be measured;
a controller that determines the complementary color information about the color information of the liquid to be measured from the color sensor;
a PWM signal unit that generated PWM signal for driving LEDs based on the complementary color information from the controller; and
LEDs that emit complementary color light according to the PWM signal from the PWM signal unit to the measurement part.

2. The graduated cylinder according to claim 1, the controller comprises a memory storing color codes and complementary color information about RGB colors.
